(19) United States
(12) Patent Application Publication
(10) Pub. No.: US 2015/0140927 A1
(43) Pub. Date: May 21, 2015

(54) WIRELESS COMMUNICATION MODULE AND PORTABLE ELECTRONIC DEVICE USING THE SAME

(71) Applicant: TAIWAN NAME PLATE CO., LTD., TAOYUAN COUNTY (TW)

(72) Inventors: FU-JUNG CHEN, Sinjhuang City (TW); HO-CHUAN HSU, NEW TAIPEI CITY (TW)

(21) Appl. No.: 14/302,769

(22) Filed: Jun. 12, 2014

Related U.S. Application Data
(60) Provisional application No. 61/906,000, filed on Nov. 19, 2013.

(51) Int. Cl. G06K 19/07; H04B 5/02; H04B 5/00

(52) U.S. Cl. CPC G06K 19/0727; H04B 5/0075; H04B 5/02; H04B 5/0062
USPC 455/41.1

(57) ABSTRACT

Disclosure is one wireless communication module comprising an antenna unit sending or receiving signals and energy; a chip unit storing signals from the antenna unit and processing them with the energy from the antenna; a coupling unit including a first and a second coupling terminals realizing a method of electromagnetic induction, resonant magnetic induction, or photoinduction to send signals and energy to each other; and a first matching terminal electrically connected to the antenna unit and the first coupling terminal to make impedance matching between the antenna unit and the first coupling terminal and a second matching unit and a second matching unit electrically connected to the chip unit and the second coupling terminal to make impedance matching between the chip unit and the second coupling terminal. The present invention also discloses a portable electronic device using the stated wireless communication module.

### CROSS-REFERENCE TO RELATED APPLICATION

This application claims the benefit of U.S. Patent Application No. 61/906,000, filed on Nov. 19, 2013, in the United States Patent and Trademark Office, the disclosure of which is incorporated herein its entirety by reference.

### BACKGROUND OF THE INVENTION

1. Field of the Invention

The present invention generally relates to a wireless communication module, in particular with respect to a wireless communication module by wireless coupling. The present invention also relates to a portable electric device using the wireless communication module.

2. Description of the Related Art

Radio frequency identification (RFID) is a radio technology which uses electromagnetic wave of the radio frequency to identify target. Generally, RFID comprises reader and tag, and the reader and the tag use electromagnetic wave of a predetermined frequency to transfer signals. Under the generally-used circumstance, the reader sends the electromagnetic wave signal and after the electromagnetic wave signal is received by the tag, signal comprising information of the tag itself is sent back to the reader via the electromagnetic wave which has the same frequency. As a result, it can determine that the detected one is the specific tag by means of the information received by the reader. In the meanwhile, the RFID tag also receives energy from the electromagnetic wave signal sent by the reader.

At present, the RFID technology has been widely using in public, such as e-ticket, digital wallet and access control management apparatus and so on and so forth. Consequently, for the sake of convenience, integrating such RFID tags in portable mobile devices, for example, smartphone, smart watch . . . and so on has become a trend. Therefore, user will have less chance of forgetting to bring the device comprising RFID tag and the convenience while using can be promoted through the integration.

The conventional method of integration is to electrically and physically connect an antenna with a chip; however, it will restrict the size of the antenna structure in the RFID tag which is used to send and receive signal and energy while the RFID tag is being integrated in portable mobile device. The size of antenna structure relates directly to the effective distance of transferring signal and energy and power consumption, so a smaller or restricted antenna structure may only have shorter signal transmission distance and result in deficiency of usage, and it is of high possibility that extra energy is necessary so that signal can be transferred effectively, and hence, it further degrades the energy usability of portable mobile device.

Under the circumstance of an antenna device is outside the chip unit establishing area, generally, substantial electric connection will be employed, but if the chip unit establishing area of portable electric device and antenna establishing area are movable or separable, substantial electric connection will hamper the relative movement between them, resulting in deficiency of usage.

### SUMMARY OF THE INVENTION

In view of the obstacle to the aforementioned prior art, the purpose of the present invention is to provide a wireless communication module to solve the problems of limitation in antenna's size while RFID technology is being integrated in portable electric device.

According to one purpose of the present invention, it may provide a wireless communication module, comprising: an antenna unit, a chip unit, a coupling unit, a first matching unit and a second matching unit. Wherein the antenna unit is configured to receive or send signals and energy; the chip unit is configured to store and process signals from the antenna unit and receive the energy from the antenna unit; the coupling unit comprises a first coupling terminal and a second coupling terminal, and the antenna unit and the chip unit transfer the signals and the energy via the coupling unit, and the first and the second coupling terminals realize electromagnetic induction, resonant magnetic induction, or photoinduction to send the signals and the energy to each other without substantial connection between the first and the second coupling terminals; the first matching unit is electrically connected between the antenna unit and the first coupling terminal for impedance matching therebetween; and the second matching unit is electrically connected between the chip unit and the second coupling terminal for impedance matching therebetween.

Preferably, the first and the second coupling terminals may transfer the signals and the energy to each other via electromagnetic induction or resonant magnetic induction.

Preferably, the first and the second coupling terminals may be formed by metal wiring, metal wiring with magnetic core, conductor printing or etching.

Preferably, the first and the second coupling terminals may be formed by metal wiring, and a coil of metal wiring may be wound on a magnetic core and the magnetic core may enclose magnetic force line to reduce energy consumption.

Preferably, the chip unit may be a radio frequency identification (RFID) chip, and the coupling unit and the antenna unit may be operated in frequency range corresponding to the RFID tag chip, and the antenna unit may exchange the signals and energy with a radiofrequency reading device corresponding to the RFID tag chip.

Preferably, the wireless communication module may further comprise a controlling unit electrically connected to the chip unit, so as to receive and send the signals from the chip unit; and a prompting unit electrically connected to the controlling unit, so as to receive the signals from the controlling unit, and generating prompting information according to the signals from the controlling unit.

According to another purpose of the present invention, it provides a wireless communication module, comprising: an antenna unit receiving or sending signals and energy; a near field communication (NFC) controller storing and processing signals from the antenna unit and receiving the energy from the antenna unit; a secure element electrically the NFC controller to realize a communication matching a communication security protocol; a coupling unit comprising a first coupling terminal and a second coupling terminal, and the antenna unit and the NFC controller transferring the signals and the energy via the coupling unit, and the first and the second coupling terminals realizing electromagnetic induction, resonant magnetic induction, or photoinduction to send the signals and the energy to each other without substantial connection between the first and the second coupling terminals; a first matching unit electrically connected between the antenna unit and the first coupling terminal for impedance matching therebetween; and a second matching unit electrically connected between the NFC controller and the second coupling terminal for impedance matching therebetween; a controlling unit electrically connected between the NFC controller and the secure element, so as to receive and send the signals from the NFC controller and the secure element; and a prompting unit electrically connected to the controlling unit, so as to receive the signals from the controlling unit, and generating prompting information according to the signals from the controlling unit.

Preferably, the wireless communication module may operate in a card emulation mode, peer to peer mode or read/write mode.

According to one more purpose of the present invention, it provides a portable electronic device comprising the preceding wireless communication module.

In accordance with the aforementioned description, the wireless communication module by wireless coupling of the present invention may have one or more advantages as follows:

(1) The wireless communication module separates the antenna structure from the chip by unsubstantial connecting coupling unit, so that the size of the antenna is not limited by the chip's structure.

(2) The wireless communication module separates the antenna structure from the chip by unsubstantial connecting coupling unit, so that the mutual interference between the antenna structure and the periphery electronic elements of the chip can be avoided.

(3) The wireless communication module is configured to transfer signals between the coupling terminals by electromagnetic induction, so that oxidation, disengagement or dirtiness of the contact points between the antenna structure and the chip due to directly contact and the resulting degradation or malfunction of transmission function thereby can be avoided.

(4) The wireless communication module transfers signals via electromagnetic induction by the coupling terminals formed of metal wiring magnetic coil so as to concentrate magnetic force line to reduce energy consumption due to the leakage of the magnetic force line.

(5) The wireless communication module connects the chip unit and secure element according to criterion of Single Wire Protocol, and packages the secure element by Universal Integrated Circuit Card, so that the wireless communication module is more compatible to the types of the chips and the integral size becomes smaller.

In accordance with the aforementioned description, wireless communication module and portable electronic device using the same according to the present invention may have one or more preceding advantages of the above-mentioned wireless communication module.

### BRIEF DESCRIPTION OF THE DRAWINGS

FIG. 1 is a system block diagram of a first embodiment of a wireless communication module according to the present invention.

FIG. 2 is a system block diagram of a second embodiment of a wireless communication module according to the present invention.

FIG. 3 is a system block diagram of a third embodiment of a wireless communication module according to the present invention.

FIG. 4 is a system block diagram of a fourth embodiment of a wireless communication module according to the present invention.

FIG. 5 is a perspective drawing of a fifth embodiment of a smart watch including a portable electronic device having a wireless communication module of FIG. 2 according to another embodiment of the present invention.

FIG. 6 is a perspective drawing of a smart watch in FIG. 5 which the watch case is separated from the watch body.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

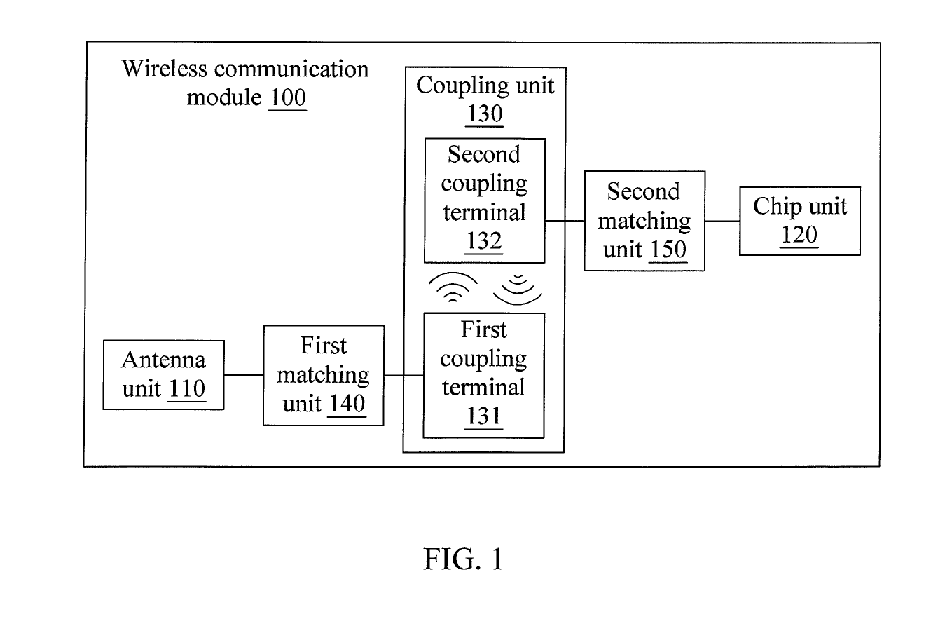

Please refer to FIG. 1 which is a system block diagram of a first embodiment of a wireless communication module according to the present invention. In the FIG., the wireless communication module 100 comprises an antenna unit 110, a chip unit 120, a coupling unit 130, a first matching unit 140 and a second matching unit 150. Wherein the antenna unit 110 is configured to receive or send signals and energy; the chip unit 120 is configured to store and process signals from the antenna unit 110 and receive the energy from the antenna unit; the coupling unit 130 comprises a first coupling terminal 131 and a second coupling terminal 132, and the antenna unit 110 and the chip unit 120 transfer the signals and the energy via the coupling unit 130, and the first and the second coupling terminals 131 and 132 realize electromagnetic induction, resonant magnetic induction, or photoinduction to send the signals and the energy to each other without substantial connection between the first and the second coupling terminals 131 and 132; the first matching unit 140 is electrically connected between the antenna unit 110 and the first coupling terminal 131 for impedance matching therebetween; and the second matching unit 150 is electrically connected between the chip unit 120 and the second coupling terminal 132 for impedance matching therebetween.

Specifically, the wireless communication module 100 is configured to integrally form a wireless communication structure, such as a structure of RFID tag, and the signals and energy transmission in the coupling unit is accomplished via unsubstantial electrical connection. Signals and energy transmission between the first and the second coupling terminals 131 and 132 can be accomplished by a method of electromagnetic induction, resonant magnetic induction, or photoinduction. The electromagnetic induction can be shown in regular transformer, the first and the second coupling terminals 131 and 132 respectively comprise inductor structure, and when a signal reaches to the first coupling terminal 131, the current of the signal flows through the inductor structure of the first coupling terminal 131; consequently, the corresponding inductor structure of the second coupling terminal 132 generates the inducing current carrying information of the signal, and the inducing current flows to the chip unit 120 to send the information of the signal to the chip unit 120, and vice versa. The resonant magnetic induction is akin to electromagnetic induction, but the first and the second coupling terminals 131 and 132 comprise inductive and capacitive structures, and the inductive and the capacitive structures of the first and the second coupling terminals 131 and 132 have predetermined parameters which enable the first and the second coupling terminals 131 and 132 having the same predetermined resonant frequency to increase signal transmission efficiency of the first and the second coupling terminals 131 and 132, but according to the transmission signal frequency, the method may need to add modulation and demodulation structures to correspond to the desired transmission signal frequency. The photoinduction accomplishes signal transmission via the transition between light and electricity, for example, the first coupling terminal 131 can comprise semiconductor laser, and the second coupling terminal 132 can comprise a light sensor corresponding the semiconductor laser, and when a signal reaches the first coupling terminal 131, semiconductor laser of the first coupling terminal 131 transmits light signal to the light sensor of the second coupling terminal 132 according to the signal, and the light sensor of the second coupling terminal 132 transforms the light signal into a current signal and send it, and vice versa. In the meanwhile, the energy for driving the electronic elements in the chip unit can be carried by the transmitted signal.

In addition, as circuit impedance between the antenna unit 110 and the first coupling terminal 131 may be not matched, for example, the output impedance of the antenna unit 110 is much higher than that of the first coupling terminal 131 and results that the signal of the antenna unit 110 is not able to enter the first coupling terminal 131 or the receiving signal efficiency of the first coupling terminal 131 is degraded. In order to solve the problem, a first matching unit 140 can be added between the antenna unit 110 and the first coupling terminal 131 to realize that the circuit impedance between the antenna 110 and the first coupling terminal 132 is matched. Similarly, the circuit impedance between the chip unit 120 and the second coupling terminal 132 may be not matched, so, a second matching unit 150 can be added between the chip unit 120 and the second coupling terminal 132 to realize that the circuit impedance between the chip unit 120 and the second coupling terminal 132 is matched.

Moreover, comparing the coupling method which is separated by substantial electric connection, for example, the junction of a detachable antenna, i.e. a structure of power plug is separable to each other, and the wireless communication module 100 transfers signals and energy via a wireless communication by the first and the second coupling terminals 131 and 132, and the first and the second coupling terminals 131 and 132 are covered by a protective structure to avoid exposing the coupling terminals such that the reduction or disappearing of the transmission efficiency between coupling terminals due to the oxidation or dirtiness of coupling terminals while substantial electric connection is conducted can be prevented.

According to the preceding description, the first and the second coupling terminals 131 and 132 transfer the signals and the energy to each other via electromagnetic induction or resonant magnetic induction.

Because the requirements for accomplishing electromagnetic induction are the least, so using electromagnetic induction as method of transferring signals can simplify the structures of the first and the second coupling terminals 131 and 132 and minimize the first and the second coupling terminals 131 and 132. However, structure of the coupling antenna in the embodiment of the present invention can also be used in resonant magnetic induction for transferring signals or energy, and the structure thereof will be explained in detail hereinafter.

Under the circumstance of the first and the second coupling terminals 131 and 132 transfer the signals and the energy to each other via electromagnetic induction or resonant magnetic induction, the first and the second coupling terminals 131 and 132 are formed by metal wiring, metal wiring with magnetic core, conductor printing or etching.

Specifically, the desired inductor structure of electromagnetic induction or resonant magnetic induction is formed by metal wiring with magnetic core, conductor printing or etching. The metal wiring method is to form a coil by a metal wire, and the metal wire with magnetic core is that a magnetic core is wired in the middle to adjust the coil's effect, where the magnetic core can be made of ferrite. The conductor printing method is to form an inductor structure pattern on circuit board and add the inductor structure on the circuit board by conventional printed circuit board technic. The etching method is akin to conductor printing method which is to form an inductor structure pattern on inductor's surface, and then to etch the inductor structure by etching.

It is noticeable that no matter which method is used to produce inductor structure, substantially, a few electric charges will be accumulated between two metal wires due to a small voltage difference. The accumulation of electric charges in the electric circuit is equivalent capacitance which is able to form structure of resonant frequency with the practical produced inductor so as to affect the efficiency of signal transmission. Therefore, thickness and partition of wire of the inductor structure is optimized to enhance the transmission efficiency.

The aforementioned first and the second coupling terminals 131 and 132 are formed by metal wiring, and furthermore, a coil of the metal wiring comprises a magnetic core and the magnetic core encloses magnetic force line to reduce energy consumption.

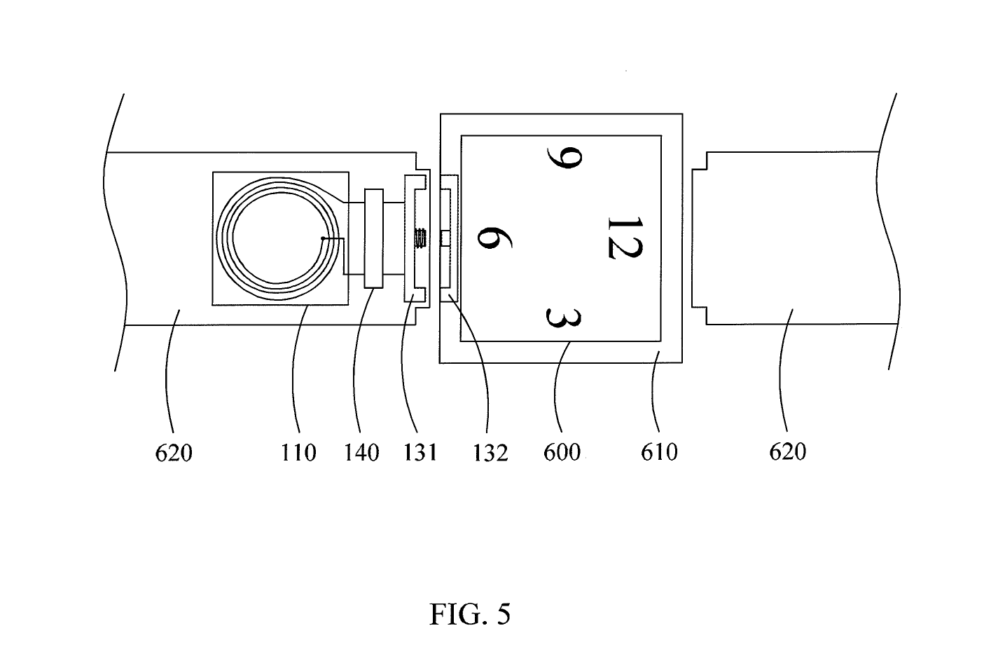

Specifically, one of influenced factors which affects the efficiency of transmission signal between two coils is ratio of the amount of magnetic force lines passing through two coils simultaneously and the amount of the magnetic force lines produced by signals, and the magnetic force line which does not pass through two coils is magnetic leakage that is regarded as energy consumption. As magnetic core is capable of enclosing plurality of magnetic force lines therein, so it can dispose magnetic core in a coil and arrange the two coils in corresponding position to enable the plurality of magnetic force lines passing through the two coils. More specifically, the magnetic core is a E shape or a U shape, and wire is coiled in E or U shape of the magnetic core closing to middle position so as to respectively form the first and the second coupling terminals 131 and 132, and the first and the second coupling terminals 131 and 132 form a ring configuration which is similar to a break in middle (referring to structures of the first and the second coupling terminals 131 and 132 shown in FIG. 5) to contribute to more magnetic force lines passing through inside of the two coils of the first and the second coupling terminals 131 and 132. In the meanwhile, as the magnetic core encloses the magnetic force line to increase the signals and energy transmission efficiency, so larger size of coupling unit is unnecessary to reach excellent signals and energy transmission efficiency and thereby the coupling unit's size can be further reduced so as to be minimized.

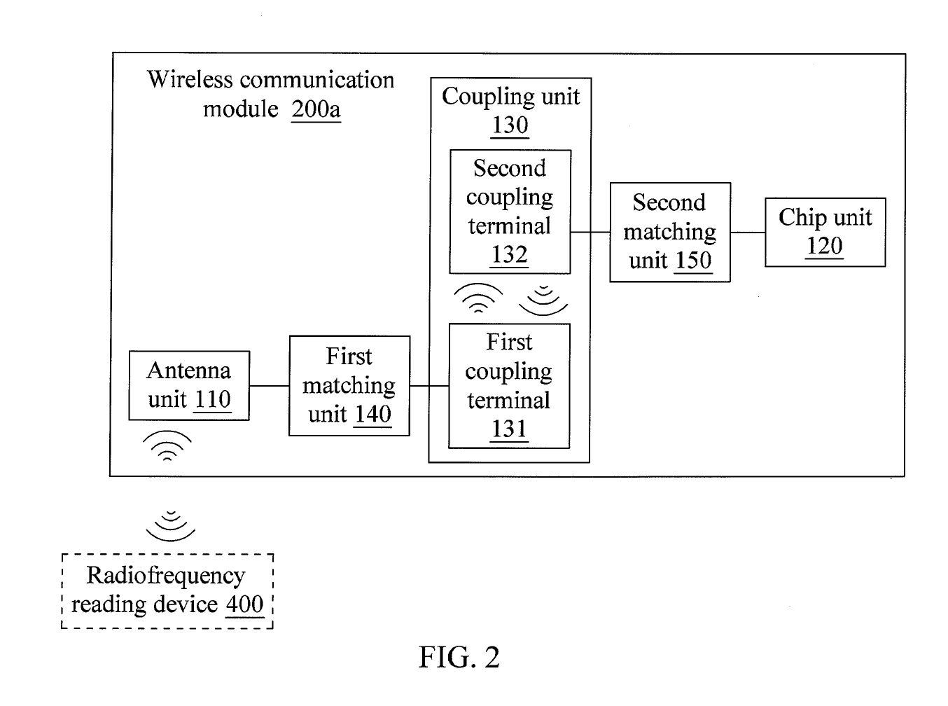

Please refer to FIG. 2 which is a system block diagram of a second embodiment of a wireless communication module according to the present invention. In the FIG., the chip unit 120 is RFID tag chip and has RFID signal interface and data storage. The coupling unit 130 and the antenna unit 110 are operated in frequency range corresponding to the RFID tag chip, and the antenna unit 110 exchanges the signals and energy with a radio frequency reading device 400 corresponding to the RFID tag chip. The operation of the wireless communication module 200a of the present embodiment is similar to that of the same elements of the wireless communication module 100 of the first embodiment. Therefore, unnecessary details are no longer given here.

Specifically, the chip unit 120 is RFID tag chip for processing RFID signals. As RFID method is of large frequency band, the other structures have to respond to the frequency modification of RFID method to achieve the optimal transmission efficiency. Under the preceding circumstance, the wireless communication module 200a is equivalent to the RFID tag which is able to exchange information with the radiofrequency reading device 400 and to couple energy from the reader for supplying power to operate the chip unit.

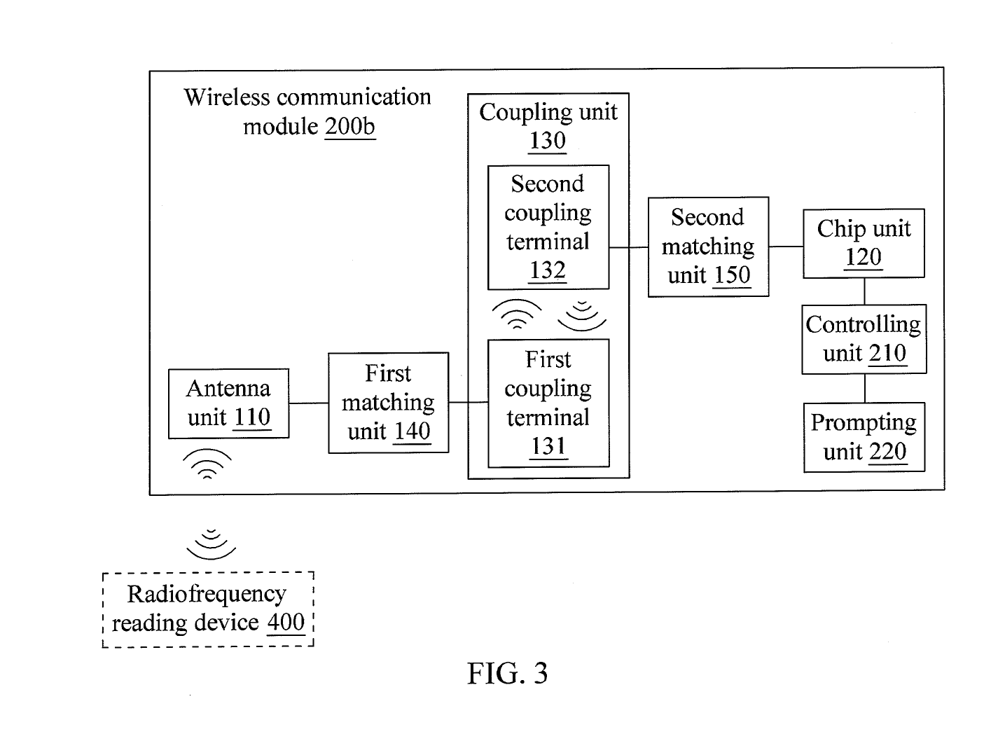

Please refer to FIG. 3 which is a system block diagram of a third embodiment of a wireless communication module according to the present invention. In the FIG., the wireless communication module 200b further comprises a controlling unit 210 and a promoting unit 220. The controlling unit 210 is electrically connected to the chip unit 120, so as to receive and send the signals from the chip unit 120; and the prompting unit 220 is electrically connected to the controlling unit 210, so as to receive the signals from the controlling unit 210, and to generate prompting information according to the signals from the controlling unit 210. The operation of the wireless communication module 200b of the present embodiment is similar to that of the same elements of the wireless communication module 200a of the second embodiment. Therefore, unnecessary details are no longer given. However, it is noticeable that in the present embodiment, user can obtain the information content stored in the chip unit 120 via the added controlling unit 210 and the promoting unit 220.

Specifically, in order to integrate RFID tag in a portable electronic device, user often hopes that the internal information stored in the RFID tag, such as balance of digital wallet, can be directly obtained without using external radio frequency reading device 400. Consequently, the wireless communication module 200b comprises the controlling unit 210 and the promoting unit 220, and by electrically connecting the controlling unit 210 with the chip unit 120, it can read the information stored in the chip unit 120 and transfer the information into signals which the promoting unit 220 can identify, and then the information content is provided to user via the promoting unit 220. For example, the controlling unit 210 is a microcontroller chip (MCU) and the promoting unit 220 is electric screen displaying information of a portable electronic device. As the microcontroller chip is not able to directly identify RFID signal format, the controlling unit 210 may comprise a chip which is applicable to identify RFID signal format and transform it into an identifiable signal format to the microcontroller chip. The structure and operation of the microcontroller chip may be the regular microcontroller chip, and therefore unnecessary details are no longer given.

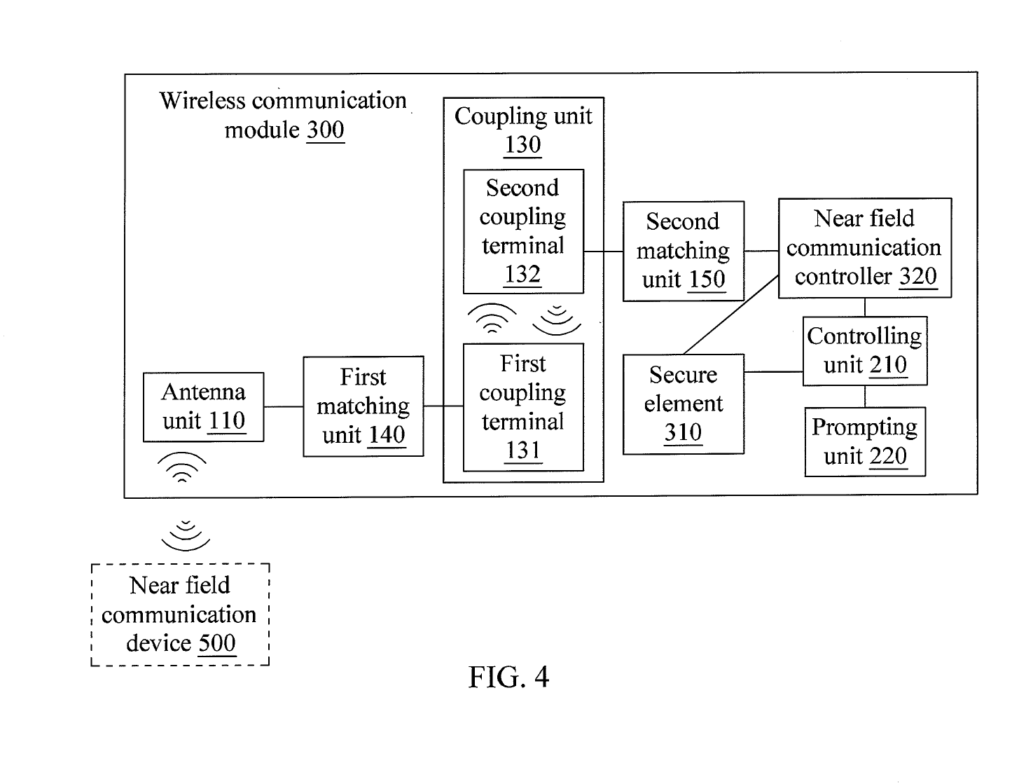

In addition, the coupling antenna technic disclosed in the present invention is suitable for being applied to near field communication (NFC) technic. Please refer to FIG. 4 which is a system block diagram of a fourth embodiment of a wireless communication module according to the present invention. In the FIG., the wireless communication module 300 comprises the antenna unit 110 receiving or sending signals and energy; a near field communication (NFC) controller 320 storing and processing signals from the antenna unit 110 and receiving the energy from the antenna unit 110; a secure element 310 configured to realize a communication matching a communication security protocol; a coupling unit 130 comprising the first coupling terminal 131 and the second coupling terminal 132, and the antenna unit 110 and the NFC controller 320 transferring the signals and the energy via the coupling unit 130, and the first and the second coupling terminals 131 and 132 realizing electromagnetic induction, resonant magnetic induction, or photoinduction to send the signals and the energy to each other, and substantial electrical connection between the first and the second coupling terminals 131 and 132 not necessary; a first matching unit 140 electrically connected between the antenna unit 110 and the first coupling terminal 131 for impedance matching therebetween; and a second matching unit 150 electrically connected between the NFC controller 320 and the second coupling terminal 132 for impedance matching therebetween; the controlling unit 210 electrically connected between the NFC controller 320 and the secure element (SE) 310, so as to receive and send the signals from the NFC controller 320 and the secure element 310; and the prompting unit 220 electrically connected to the controlling unit, so as to receive the signals from the controlling unit 210, and generating prompting information according to the signals from the controlling unit 210. At the moment, the coupling unit 130 and the antenna unit 110 are operated in frequency range corresponding to the NFC method. A device including the wireless communication module 300 substantially has NFC function and be able to communicate with another device with NFC function (as NFC device 500 in FIG. 4). The operation of the wireless communication module 300 of the present embodiment is the same as that of the same elements of the wireless communication module 200b of the third embodiment. Therefore, unnecessary details are no long given. However, it is noticeable that in the present embodiment, user can accomplish a security communication matching a predetermined communication security protocol via the added secure element 310 and to conduct communicating with other NFC devices via the NFC controller 320.

The technology of NFC is developed from RFID technic, and both are wireless communication technologies which can be minimized. Therefore, it can be applied to the wireless communication module of the present invention. Refer to the system in FIG. 1 and as shown in FIG. 4, the antenna unit 110 and the coupling unit 130 correspond with the electromagnetic wave frequency used by NFC technology, the second coupling terminal 132 of the coupling unit 130 is electrically connected to the NFC controller 320 so as to communicate with the other NFC devices. Specifically, the wireless communication module 300 comprising the NFC controller 320 and the secure element 310 is able to accomplish operating modes, such as card emulation mode, peer to peer mode and read/write mode. The effect of card emulation mode is akin to that realized by the RFID tag chip of the second and third embodiments of the present invention. When the NFC controller 320 and the secure element 310 receive the signal from the external reader, they passively provide information to the external storage. It is worthy to mention that the secure element 310 connects with the controlling unit 210 according to criterion of ISO7816 to provide sensitive information, such as balance . . . etc. to the controlling unit 210 and the controlling unit 210 thereby provides it to the promoting unit 220 so that it can be provided to and known by the user. Peer to peer mode means that information can be exchanged between two NFC devices, and the two NFC devices can easily conduct connecting in an effective near field range towards the NFC devices without using additional devices and complicated setting procedures. The read/write mode is to make the NFC controller 320 in active mode to not only serve as a read tag, but also a reader for reading the other tags.

In addition, the wireless communication module 300 comprises the secure element 310 which belongs to an encryption chip matching the security standard and can store sensitive information, such as personal data . . . etc., and the function thereof comprises the RFID tag storing information function of the chip unit 120 of the second and third embodiments of the present invention to accomplish the function of security communication.

In the configuration, the NFC controller 320 can use various methods to connect with the secure element 310, such as Signal/Signal Out Connection (S²C), signal wire protocol and so on. The secure element 310 also conducts packing by various methods, such as Universal Integrated Circuit Card (UICC), micro SD and so on, or being built-in directly in the NFC controller 320.

Please refer to FIG. 5 which is a perspective drawing of a fifth embodiment of a smart watch including a portable electronic device having a wireless communication module according to the above described embodiment of the present invention. In the embodiment, the used wireless communication module is the wireless communication module 300b shown in FIG. 3, and portable electronic device is a smart watch. A watch body 600 of the smart watch is embedded in a watch case 610 and comprises the chip unit 120, the second matching unit 150, the controlling unit 210, the promoting unit 220 comprised in the wireless communication module 200b. The second coupling terminal 132 is connected to the watch body 600 and corresponds to the position of the first coupling terminal 131 in left of watch strap 620; the antenna unit 110 and the first matching unit 140 are located in left of the watch strap 620; similarly, the first matching unit 140 is connected between the antenna unit 110 and the first coupling terminal 131, the antenna unit accomplishes transferring signals and energy via the first and the second coupling terminals 131 and 132 along with the chip unit 120 embedded in the watch body 600.

Specifically, deposing the antenna unit 110 in the watch body 600 will limit an antenna′ size and the antenna unit 110 may interfere with the internal electronic elements embedded in the watch body 600; consequently, arranging the antenna unit 110 outside the watch body 600 is desired. However, a certain level of relative movement between the watch body 600 and the watch strap 620 is necessary when using a regular watch, such as an end of the watch strap 620 is connected to rotation axis of the watch body 600 so as to be rotated on the watch body 600. Under the circumstance, substantial electric connection will hinder the relative movement between the watch body 600 and the watch strap 620, so that the wireless communication module of the present invention is utilized. As a result, the antenna unit 110 is spaced apart from the structure of the watch body 600 and is located on watch strap's position, and the relative movement between the watch body 600 and the watch strap 620 is therefore not interfered. In the meanwhile, the width of the antenna unit 110 can be maximized to that of watch trap so as to enhance the transmission distance and intensity for signals and energy. Additionally, side of the watch case 610 relative to direction of the antenna unit 110 may have an opening, so that signals and energy transmission between the two coupling terminals 131 and 132 of the coupling unit 130 will not be blocked, and the first coupling terminal 131 of the watch strap 620 has a small activity space. Moreover, E shape end point between the two coupling terminals 131, 132 of the coupling unit 130 is not closed entirely, so that a small relative movement can still exist between the two coupling terminals 131, 132, and after testing, in case there is a tiny predetermined gap in E shape end point between the two coupling terminals 131, 132 of the coupling unit 130, efficiency of signals and energy transmission can be further increased.

In the embodiment, the controlling unit 210 is a microcontroller chip of a smart watch, and the promoting unit 220 is a screen of the smart watch.

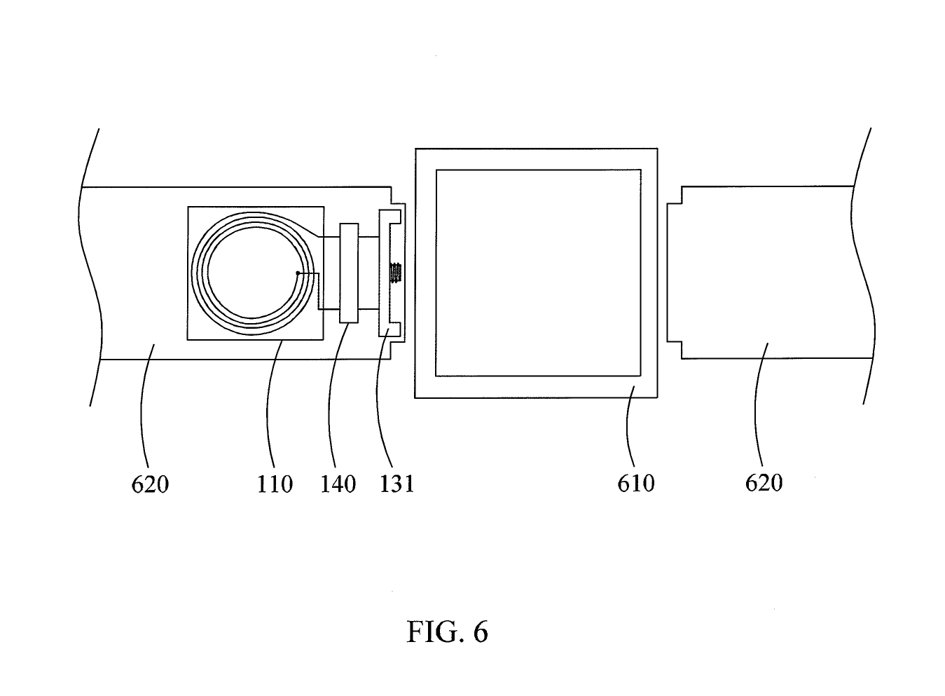

Please refer to FIG. 6 which is a perspective drawing of a smart watch in FIG. 5 which the watch case is separated from the watch body. As can be seen in the FIG., the watch body 600 and the second coupling terminal 132 connected therewith are removed from the watch strap 620.

As the watch body 600 and the watch strap 620 are separated substantially, so, no matter chip portion of the watch body 600 or antenna portion of the watch strap 620 is damaged or malfunctioned, it only needs to replace the corresponding portion without replacing the entirety of the smart watch and conducting wiring after the replacement is completed, and as result, effect of arranging the watch body 600 on the watch strap 620 which is akin to effectiveness of plug and play can be reached.

The smart watch may comprise communication module having NFC function of the wireless communication module 300. In the meanwhile, the smart watch therefore has the preceding NFC function. For example, when operating card emulation mode, the smart watch can be functioned as access control card or wave and pay card, and when access or payment is required, and smart watch approaching reader is the only action required to complete verification or deal. When operating peer to peer mode, smart watch only needs to approach the other NFC devices, such as the other smart watches or phones, to exchange of information with each other, such as calendar or music and so on can be executed. When operating read/write mode, the smart watch can be used as reader or tag, for example when using two smart watches to conduct transferring from one to another by digital wallet function, one smart watch used as receipt can be served as reader, and the other used as payer can be served as tag, and after the both are connected to the central server of the digital wallet system and sense each other, the deal is thereby completed. Therefore, the smart watch with NFC function can be used in various way in daily life for convenience, such as contactless credit card, electronic ticket and digital wallet.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A wireless communication module, comprising:
an antenna unit receiving or sending signals and energy;
a chip unit storing and processing the signals from the antenna unit and receiving the energy from the antenna unit;
a coupling unit comprising a first coupling terminal and a second coupling terminal, and the antenna unit and the chip unit transferring the signals and the energy via the coupling unit, and the first and the second coupling terminals realizing electromagnetic induction, resonant magnetic induction, or photoinduction to send the signals and the energy to each other without substantial connection between the first and the second coupling terminals;
a first matching unit electrically connected between the antenna unit and the first coupling terminal for impedance matching therebetween; and
a second matching unit electrically connected between the chip unit and the second coupling terminal for impedance matching therebetween.

2. The wireless communication module as defined in claim 1, wherein the first and the second coupling terminals transfer the signals and the energy to each other via electromagnetic induction or resonant magnetic induction.

3. The wireless communication module as defined in claim 2, wherein the first and the second coupling terminals are formed by solely metal wiring, metal wiring with magnetic core, conductor printing or etching.

4. The wireless communication module as defined in claim 3, wherein the first and the second coupling terminals are formed by metal wiring with magnetic core, and a coil of metal wiring are wound on a magnetic core and the magnetic core encloses magnetic force line to reduce energy consumption.

5. The wireless communication module as defined in claim 3, wherein the chip unit is a radio frequency identification (RFID) tag chip, and the coupling unit and the antenna unit are operated in frequency range corresponding to the RFID tag chip, and the antenna unit exchanges the signals and energy with a radio frequency reading device corresponding to the RFID tag chip.

6. The wireless communication module as defined in claim 5, further comprising:
a controlling unit electrically connected to the chip unit, so as to receive and send the signals from the chip unit; and
a prompting unit electrically connected to the controlling unit, so as to receive the signals from the controlling unit, and generating prompting information according to the signals from the controlling unit.

7. A wireless communication module, comprising:
an antenna unit receiving or sending signals and energy;
a near field communication (NFC) controller storing and processing the signals from the antenna unit and receiving the energy from the antenna unit;
a secure element electrically the NFC controller to realize a communication matching a communication security protocol;
a coupling unit comprising a first coupling terminal and a second coupling terminal, and the antenna unit and the NFC controller transferring the signals and the energy via the coupling unit, and the first and the second coupling terminals realizing electromagnetic induction, resonant magnetic induction, or photoinduction to send the signals and the energy to each other without substantial connection between the first and the second coupling terminals;
a first matching unit electrically connected between the antenna unit and the first coupling terminal for impedance matching therebetween; and
a second matching unit electrically connected between the NFC controller and the second coupling terminal for impedance matching therebetween;
a controlling unit electrically connected between the NFC controller and the secure element, so as to receive and send the signals from the NFC controller and the secure element; and
a prompting unit electrically connected to the controlling unit, so as to receive the signals from the controlling unit, and generating prompting information according to the signals from the controlling unit.

8. The wireless communication module as defined in claim 7, wherein the wireless communication module operates in a card emulation mode, peer to peer mode or read/write mode.

9. A portable electronic device comprising a wireless communication module, and the wireless communication module comprising:
an antenna unit receiving or sending signals and energy;
a chip unit storing and processing the signals from the antenna unit and receiving the energy from the antenna unit;
a coupling unit comprising a first coupling terminal and a second coupling terminal, and the antenna unit and the chip unit transferring the signals and the energy via the coupling unit, and the first and the second coupling terminals realizing electromagnetic induction, resonant magnetic induction, or photo induction to send the signals and the energy to each other, and substantial electrical connection between the first and the second coupling terminals not necessary;
a first matching unit electrically connected between the antenna unit and the first coupling terminal for impedance matching therebetween; and
a second matching unit electrically connected between the chip unit and the second coupling terminal for impedance matching therebetween.

10. The portable electronic device as defined in claim 9, wherein the first and the second coupling terminals transfer the signals and the energy to each other via electromagnetic induction or resonant magnetic induction.

11. The portable electronic device as defined in claim 10, wherein the first and the second coupling terminals are formed by solely metal wiring, metal wiring with magnetic core, conductor printing or etching.

12. The portable electronic device as defined in claim 11, wherein the first and the second coupling terminals are formed by metal wiring with magnetic core, and a coil of metal wiring is wound on a magnetic core and the magnetic core encloses magnetic lines of force to reduce energy consumption.

13. The portable electronic device as defined in claim 11, wherein the chip unit is a radio frequency identification (RFID) tag chip, and the coupling unit and the antenna unit are operated in frequency range corresponding to the RFID tag chip, and the antenna unit exchanges the signals and energy with a radiofrequency reading device corresponding to the RFID tag chip.

14. The portable electronic device as defined in claim 13, wherein the wireless communication module further comprising:
a controlling unit electrically connected to the chip unit, so as to receive and send the signals from the chip unit; and
a prompting unit electrically connected to the controlling unit, so as to receive the signals from the controlling unit, and generating prompting information according to the signals from the controlling unit.

15. A portable electric device comprising a wireless communication module, and the wireless communication module comprising:
an antenna unit receiving or sending signals and energy;
a near field communication (NFC) controller storing and processing the signals from the antenna unit and receiving the energy from the antenna unit;
a secure element electrically the NFC controller to realize a communication matching a communication security protocol;
a coupling unit comprising a first coupling terminal and a second coupling terminal, and the antenna unit and the NFC controller transferring the signals and the energy via the coupling unit, and the first and the second coupling terminals realizing electromagnetic induction, resonant magnetic induction, or photoinduction to send the signals and the energy to each other, and substantial electrical connection between the first and the second coupling terminals not necessary;
a first matching unit electrically connected between the antenna unit and the first coupling terminal for impedance matching therebetween; and
a second matching unit electrically connected between the NFC controller and the second coupling terminal for impedance matching therebetween;
a controlling unit electrically connected between the NFC controller and the secure element, so as to receive and send the signals from the NFC controller and the secure element; and
a prompting unit electrically connected to the controlling unit, so as to receive the signals from the controlling unit, and generating prompting information according to the signals from the controlling unit.

16. The portable electronic device as defined in claim 15, wherein the wireless communication module operates in a card emulation mode, peer to peer mode or read/write mode.

17. The portable electronic device as defined in claim 15, wherein the portable electronic device serves as a contactless credit card, electronic ticket or digital wallet.
